(19) United States
(12) Patent Application Publication
(10) Pub. No.: US 2026/0003577 A1
(43) Pub. Date: Jan. 1, 2026

(54) MODEL EXECUTION WORKFLOW ENGINE

(71) Applicant: FMR LLC, Boston, MA (US)

(72) Inventors: Raghuram Vemuri, Cary, NC (US); Bhargav Tumu, Durham, NC (US); Arun Aithal Subbanna, Apex, NC (US); Jatinder Kumar, Apex, NC (US); Ramanathan Natarajan, Tamil Nadu (IN); Avishek Pradhan, Karnataka (IN); Sunil Gurusiddappa, Cary, NC (US); Ravi Krishnamurthy, Apex, NC (US)

(21) Appl. No.: 18/756,894

(22) Filed: Jun. 27, 2024

(51) Int. Cl. G06F 8/20; G06F 8/33

(52) U.S. Cl. CPC G06F 8/20; G06F 8/33

(57) ABSTRACT

A method for executing a machine learning model using a workflow engine includes receiving a model configuration including data related to the machine learning model, pre-processing steps having first prerequisites, and post-processing steps having second prerequisites; in response to a determination that the first prerequisites are not met, executing first operations; in response to a determination that the second prerequisites are not met, executing second operations; executing the pre-processing steps to provide first data, the first data including model inputs; causing transmission of the first data from the computer system to the cloud server system; causing execution of the machine learning model on the cloud server system; causing transmission of second data from the cloud server system to the computer system, the second data including an output of the machine learning model; executing the post-processing steps.

### BACKGROUND

### Technical Field

The present invention relates to machine learning workflow engines, and more specifically to a model execution workflow engine that allows for automated deployment and execution of a machine learning model on a cloud server system.

### Background

The increased use of machine learning models presents a paradigm shift from the common software engineering practice of designing, developing, and deploying an application. The non-deterministic nature of machine learning models means that their behavior and efficiency is driven by input data in production and that they may have to be monitored and updated in real-time using the production data. In addition, deploying a machine learning model to production currently requires a combination of data scientists, data engineers, and software engineers. A data scientist first builds a model by defining its architecture, hyperparameters, and weights. A data engineer then develops code to manage execution of the model and to provide pre- and post-processing. A software engineer reviews and refines the code before eventually deploying the model. Any change to the model requires a new iteration of this pipeline. On average, a team of data scientists, data engineers, and software engineers may spend up to 160 man-hours to deploy a model.

### SUMMARY

The deficiencies of the prior art are remedied by providing a model execution framework that significantly reduces the time required to deploy and execute a machine learning model. The framework described herein provides a solution for data scientists to define and deploy models without requiring the assistance of data engineers and/or software engineers. Data scientists have the flexibility to develop scripts that define the model and any necessary pre-processing and post-processing. The remaining deployment process is then performed automatically by the workflow engine described herein.

In accordance with an embodiment of the present invention, a computer-implemented method for executing a machine learning model on a cloud server system using a workflow engine executing on a computer system includes receiving, by the workflow engine, a model configuration including data related to the machine learning model, pre-processing steps having first prerequisites, and post-processing steps having second prerequisites. The method includes determining, by the workflow engine, whether the first prerequisites are met. The method also includes, in response to a determination that the first prerequisites are not met, executing, by the workflow engine, first operations such that after execution of the first operations the first prerequisites are met. The method includes determining, by the workflow engine, whether the second prerequisites are met. The method includes, in response to a determination that the second prerequisites are not met, executing, by the workflow engine, second operations such that after execution of the second operations the second prerequisites are met. The method further includes executing, by the workflow engine, the pre-processing steps to provide first data, the first data including model inputs. The method includes causing, by the workflow engine, transmission of the first data from the computer system to the cloud server system. The method includes causing, by the workflow engine, execution of the machine learning model on the cloud server system. The method also includes causing, by the workflow engine, transmission of second data from the cloud server system to the computer system, the second data including an output of the machine learning model. The method includes executing, by the workflow engine, the post-processing steps.

Alternatively, or in addition, the workflow engine is configured to execute the machine learning model on a plurality of different types of cloud server systems. The post-processing steps may include storing, by the workflow engine, the output of the machine learning model in a database. The pre-processing steps may include retrieving, by the workflow engine, the model inputs from a database.

Alternatively, or in addition, the method further includes selecting, by the workflow engine, the cloud server system for executing the machine learning model from a plurality of potential cloud server systems. Selecting the cloud server system from a cloud provider may be based on the output of a second machine learning model and data compliance. Selecting the cloud server system may also be based on at least one of a set of rules, heuristics, and user input.

Alternatively, or in addition, the method further includes comprising monitoring, by at least one of the workflow engine and the cloud server system, a performance of the machine learning model during execution. At least one of the first prerequisites and the second prerequisites may include at least one of a storage location and a user access permission.

Alternatively, or in addition, the method further includes comprising observability, where the workflow engine publishes the necessary signals that describe the health of the model and the infrastructure at any given time.

In accordance with another embodiment of the present invention, a system for processing a model execution workflow includes a cloud server system configured to execute a machine learning model. The system also includes a computer system having a processor coupled to a memory, the computer system communicatively coupled to the cloud server system, the processor configured to execute a workflow engine. The workflow engine is configured to receive a model configuration including data related to the machine learning model, pre-processing steps having first prerequisites, and post-processing steps having second prerequisites. The workflow engine is configured to determine whether the first prerequisites are met. The workflow engine is configured to, in response to a determination that the first prerequisites are not met, execute first operations such that after execution of the first operations the first prerequisites are met. The workflow engine is configured to determine whether the second prerequisites are met. The workflow engine is configured to, in response to a determination that the second prerequisites are not met, execute second operations such that after execution of the second operations the second prerequisites are met. The workflow engine is configured to execute the pre-processing steps to provide first data, the first data including model inputs. The workflow engine is configured to cause transmission of the first data from the computer system to the cloud server system. The workflow engine is configured to cause execution of the machine learning model on the cloud server system. The workflow engine is configured to cause transmission of second data from the cloud server system to the computer system, the second data including an output of the machine learning model. The workflow engine is configured to execute the post-processing steps.

Alternatively, or in addition, the workflow engine is configured to execute the machine learning model on a plurality of different types of cloud server systems. The system may further include a database communicatively coupled to the computer system, and the post-processing steps may include storing the output of the machine learning model in a database. The pre-processing steps may include retrieving the model inputs from a database.

Alternatively, or in addition, the workflow engine is further configured to select the cloud server system for executing the machine learning model from a plurality of potential cloud server systems. Selecting the cloud server system may be based on the output of a second machine learning model.

Alternatively, or in addition, the workflow engine is further configured to monitor a performance of the machine learning model during execution. The workflow engine may be configured to select the cloud server system based on the monitored performance during a previous execution of the machine learning model. At least one of the first prerequisites and the second prerequisites may include at least one of a storage location and a user access permission.

In accordance with yet another embodiment of the present invention, a non-transitory computer-readable medium has software encoded thereon. The software, when executed by a computer system coupled to a cloud server system, is operable to receive a model configuration including data related to a machine learning model, pre-processing steps having first prerequisites, and post-processing steps having second prerequisites. The software is operable to determine whether the first prerequisites are met. The software is operable to, in response to a determination that the first prerequisites are not met, execute first operations such that after execution of the first operations the first prerequisites are met. The software is operable to determine whether the second prerequisites are met. The software is operable to, in response to a determination that the second prerequisites are not met, execute second operations such that after execution of the second operations the second prerequisites are met. The software is operable to execute the pre-processing steps to provide first data, the first data including model inputs. The software is operable to cause transmission of the first data from the computer system to the cloud server system. The software is operable to cause execution of the machine learning model on the cloud server system. The software is operable to cause transmission of second data from the cloud server system to the computer system, the second data including an output of the machine learning model. The software is operable to execute the post-processing steps. In some embodiments, at least one of the cloud server system and the workflow engine is further configured to observe the process metrics of the machine learning model platform during execution.

### BRIEF DESCRIPTION OF THE DRA WINGS

The description below refers to the accompanying drawings, of which:

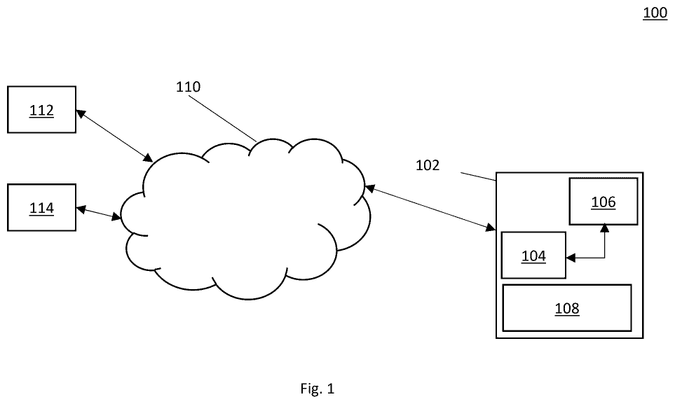

FIG. 1 is an illustration of a system for executing a model execution workflow engine in accordance with an embodiment of the present invention;

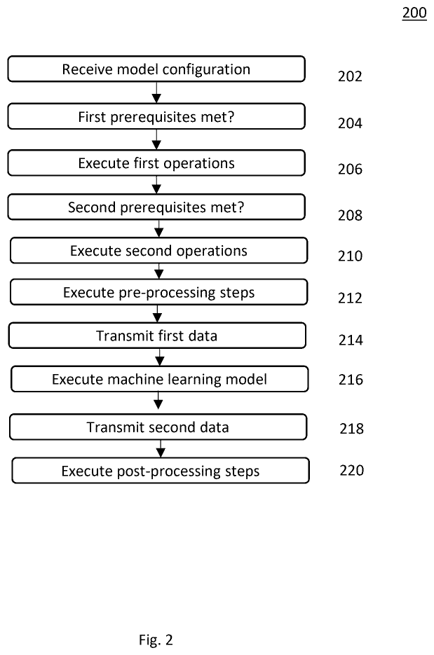

FIG. 2 is a flowchart of a method for executing a machine learning model using a a workflow engine in accordance with an embodiment of the present invention; and

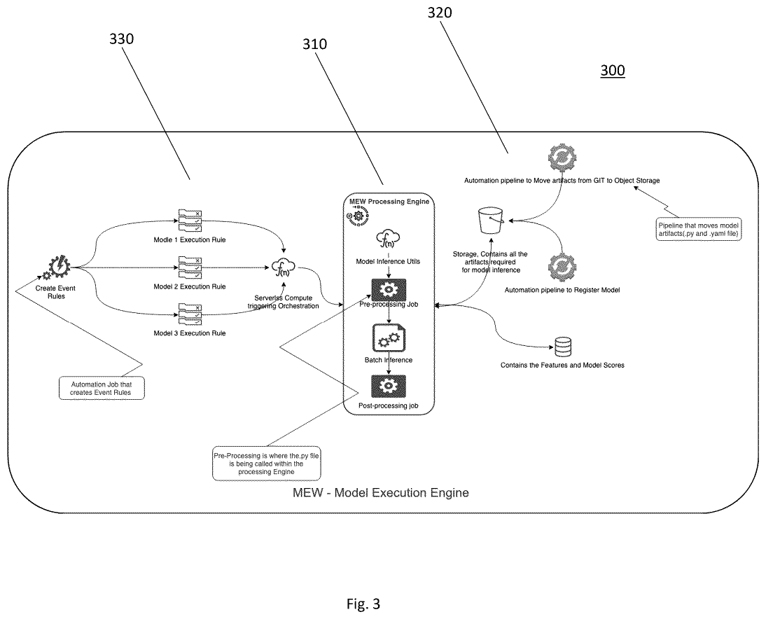

FIG. 3 is an illustration of a system architecture in accordance with an embodiment of the present invention.

### DETAILED DESCRIPTION OF ILLUSTRATIVE EMBODIMENTS

FIG. 1 is an illustration of a system 100 for executing a model execution workflow engine in accordance with an embodiment of the present invention. System 100 includes a computer system 102. The computer system 102 has a processor 104 coupled to a memory 106. The computer system 102 may also be communicatively coupled to a communications network 110. Network 110 may be a public network, such as the internet, or it may be a private network, such as a network internal to a company. Network 110 also may be a combination of public and/or private networks. The computer system 102 may be coupled to the network 110 directly, for example via an Ethernet cable or via wireless connection such as Wi-Fi. Computer system 102 may also be coupled to the network 110 in any other way known to the skilled person, for example indirectly through another device (not shown), such, as, but not limited to, a router, a switch, a hub, a separate computer system, a mobile device, a modem, and/or a combination of these devices. Computer system 102 also includes a model execution workflow engine 108. The processor 104 is configured to execute workflow engine 108, and workflow engine 108 is configured to execute the method described below in detail with reference to FIG. 2. While a processor 104 is described herein, it is expressly contemplated that the computer system 102 has a plurality of processors. In that case, each of the plurality of processors of computer system 102 is coupled to the memory 106 and is configured to execute workflow engine 108.

Also communicatively coupled to the network 110 is a cloud server system 112. The cloud server system 112 may be accessed by the computer system 102 over the network 110 and enables the computer system 102 to cause execution of a machine learning model. Exemplarily, the cloud server system 112 may be a commercially available machine learning platform that provides and executes one or more machine learning models. This machine learning platform enables users to create, train, and deploy machine learning models in the cloud and/or on dedicated computing devices. The platform also allows for different levels of abstraction: it provides pre-trained machine learning models that may be used as is, it provides machine learning models that users may train on their own data, and it provides mechanisms to create machine learning models and algorithms from scratch. It is expressly noted, as further explained below, that any other suitable machine learning platform known to the skilled person, accessible either publicly or privately or on-premise.

Further coupled to the network 110 may be a database 114. The database 114 may be provided by any publicly available database system known to the skilled person. It may be a commercial database or an open-source database. While the database 114 is shown here coupled to the network 110, it is also expressly contemplated that the database 114 may be hosted on the computer system 102. The database 114 allows the computer system 102 to store and retrieve data.

FIG. 2 is a flowchart of a computer-implemented method 200 for executing a machine learning model on a cloud server system using a workflow engine in accordance with an embodiment of the present invention. Specifically, method 200 may be executed by workflow engine 108 that is executed by one or more processors 104 of computer system 102 as described above with reference to FIG. 1. Similar to what is described above, the computer system 102 is coupled to a communications network 110. Also coupled to the communications network 110, or hosted on the computer system 102, may be a cloud server system 112 and a database 114, as described above.

In step 202, the workflow engine 108 receives a model configuration that includes data related to a machine learning model, pre-processing steps having first prerequisites, and post-processing steps having second prerequisites. The model configuration may be provided in any suitable format known to the skilled person. For example, the model configuration may be provided in a data-serialization language such as YAML (publicly available at yaml.org) that is easily human-readable and human-editable but also supported by many programming languages. The computer system 102 may receive the configuration and the application over the network 110, from a file system, from the database 114, or from any other suitable source. The computer system 102 may also receive the application and its configuration from a model repository. The model repository may be any suitable repository known to the skilled person. Illustratively, the model repository may be stored on computer system 102 itself, such as in the computer system's file system or memory 106. In other embodiments, the model repository may be stored in database 114, or it may be stored and/or hosted on a different device coupled to the network 110. In that case, the computer system 102 receives the model configuration over the network 110. The model configuration may include parameters and their associated values for various aspects of the machine learning model and its execution. For example, the configuration may include parameters related to one or more of an identification of the model (such as the model name), an identification of the cloud server system hosting the model, parameters related to communication with the model and the cloud server system, parameters related to model inputs and model outputs, parameters related to first prerequisites, pre-processing steps, second prerequisites, post-processing steps, and/or any other suitable parameter known to the skilled person.

In some embodiments, the workflow engine 108 validates the received model configuration. The validation may be performed in any manner known to the skilled person. For example, the workflow engine 108 may validate the model configuration using predefined configuration templates and/or scripts. In another example, the workflow engine 108 may lint the model configuration using a linting engine and/or rule engine. Such validation ensures that the model configuration does not violate certain unnegotiable parameters. For example, the workflow engine 108 may ensure that the model configuration follows security best practices and is compliant with any business policies that may be applicable to the model application. To this end, the workflow engine 108 may evaluate and validate the configuration based on a set of rules that have been predefined for the machine learning model. These rules may have been predefined based on experience over a period of time and/or best practices in the business or industry. The workflow engine 108 may retrieve these rules from a file system, from the database 114, or over the network 110. The rules may define required values or value ranges for certain configuration parameters. If the model configuration meets these values, the configuration passes validation step. If the model configuration does not meet these values, the configuration fails the validation step. The workflow engine 108 may generate a pass or fail result of each configuration value and/or for the entire model configuration.

Notably, since the model configuration includes information about the machine learning model and the cloud server system and how to communicate with it, the system and method described herein is agnostic as to which cloud server system is used. Illustratively, the workflow engine 108 is configured to cause execution of the machine learning model on a plurality of different types of cloud server systems. The workflow engine 108 initially may be configured to communicate with and cause execution of a machine learning model hosted on machine learning platform, as described above. If the machine learning platform becomes unavailable, the model configuration can easily be adapted to access and execute a model on a competitor's cloud server system. In addition, the model configuration can also easily be adapted to access and execute a model on a private cloud server system. This allows developers to first test new models using a public server before setting up an in-house server to provide the same services. Advantageously, very few configuration parameters need to be changed to move execution of the model from one cloud service to another. In other embodiments, the model configuration may include more than one cloud server system option for the model to be executed on. The model workflow engine 108 then selects the optimal cloud server system for execution of the model as described in detail further below.

In step 204, the workflow engine 108 determines whether the first prerequisites are met. The first prerequisites are included in the model configuration and relate to prerequisites for the pre-processing steps that are also part of the model configuration. In an example, the first prerequisites may include information about database connections, database tables and/or database records that are required for execution of the machine learning model. In that case, the model configuration may indicate that input data for the machine learning model may be found in a certain table of a certain database. The first prerequisites then include an identification of that database and how to connect to it, such as a username and password for a database server. The workflow engine 108 then determines whether the database server is accessible, for example over network 110, and whether the given username and password are valid credentials for the database server. Next, the workflow engine 108 determines whether the database and the given table in that database exist. The workflow engine 108 also determines whether the data to be used as input data exists in the database table. In another example, the first prerequisites may indicate that the input data for the machine learning model may be found in the file system of computer system 102. The workflow engine 108 then determines whether the file indicated in the model configuration exists and whether it contains the required data. The first prerequisites may also include a requirement that the machine learning model exists and is accessible through one or more cloud server systems.

In step 206, the workflow engine 108 executes first operations in response to a determination that the first prerequisites are not met. The workflow engine 108 executes the first operations such that after their execution the first prerequisites are met. The first operations may be included in the model configuration. For example, the first operations may include an operation to connect to the database if a database connection is not available yet. In another example, the first operations may include generating a database and/or a table and importing data that will be used as an input for the model into the database or into the file system. In yet another example, the first operations may include operations to generate required input data. The first prerequisites are fulfilled after execution of the first operations. Illustratively, if the first prerequisites include a database connection that does not exist yet, the first operations may include an operation to establish that database connection to a database server. After establishing the connection, the prerequisite of an established database connection is fulfilled. In another example, the first prerequisites include certain access permissions for a database user. If the workflow engine 108 determines that the username given in the model configuration does not have the required database access, the first operations may include an operation to grant the user the permissions required to access the database. It is also expressly noted that the workflow engine 108 may not execute any first operations because all first prerequisites were determined to be met in step 204. In other words, the first operations may be an empty set.

In step 208, the workflow engine 108 determines whether the second prerequisites are met. Similar to what is described above with reference to step 204, the second prerequisites are included in the model configuration and relate to prerequisites for the pre-processing steps that are also part of the model configuration. In an example, the second prerequisites may include information about database connections, database tables and/or database records that are required to store the output of the machine learning model and/or performance data related to execution of the machine learning model. In that case, the model configuration may indicate that output data for the machine learning model is to be stored in a certain table of a certain database. The second prerequisites then include an identification of that database and how to connect to it, such as a username and password for a database server. The workflow engine 108 then determines whether the database server is accessible, for example over network 110, and whether the given username and password are valid credentials for the database server. Next, the workflow engine 108 determines whether the database and the given table in that database exist. In another example, the second prerequisites may indicate that the output of the machine learning model may be stored in the file system of computer system 102. The workflow engine 108 then determines whether the storage location indicated in the model configuration exists.

In step 210, the workflow engine 108 executes second operations in response to a determination that the second prerequisites are not met. The workflow engine 108 executes the second operations such that after their execution the second perquisites are met. The second operations may be included in the model configuration. For example, the second operations may include an operation to establish a connection to the database if a database connection is not available yet. In another example, the second operations may include generating a database and/or second table for storage of the machine learning model output. In yet another example, the first operations may include operations to create a file systems storage location for model output data. The second prerequisites are fulfilled after execution of the second operations. Illustratively, if the second prerequisites include a database connection that does not exist yet, the second operations may include an operation to establish that database connection to a database server. After establishing the connection, the prerequisite of an established database connection is fulfilled. In another example, the second prerequisites include certain access permissions for a database user. If the workflow engine 108 determines that the username given in the model configuration does not have the required database access, the second operations may include an operation to grant the user the permissions required to access the database. It is also expressly noted that the workflow engine 108 may not execute any second operations because all first prerequisites were determined to be met in step 208. In other words, the second operations may be an empty set. In addition, the workflow engine 108 is also flexible to add to the series of checks such as first and second prerequisites and execute the corresponding operation either consecutively or in a parallel way.

In step 212, the workflow engine 108 executes the pre-processing steps. Execution of the pre-processing steps provides first data. The first data includes inputs for the machine learning model. For example, the workflow engine 108 may utilize a database connection and credentials provided in the model configuration to access a database. The workflow engine 108 may then retrieve data from a given table in a given database. This retrieved data may be the first data that includes inputs for the machine learning model. In another example, the workflow engine 108 may process the retrieved data to result in the first data that includes the model inputs. The workflow engine 108 may process the retrieved data in any manner known to the skilled person. For example, the workflow engine 108 may aggregate the retrieved data to result in the first data. In another example, the workflow engine 108 may execute another application to process the retrieved data. The output of that other application is then utilized as the first data that includes the model inputs.

The workflow engine 108 may execute the pre-processing steps in any way known to the skilled person. For example, the pre-processing steps may refer to one or more scripts that are executed by the workflow engine 108 on computer system 102. The pre-processing steps may also refer to separate applications and/or containers that are available for execution on computer system 102. The workflow engine 108 may cause execution of these applications and/or containers to execute the pre-processing steps. The pre-processing steps may further refer to applications that are available in the cloud over network 110. In that case, the workflow engine 108 may transmit data over network 110 to the cloud application, cause execution of the cloud application, and then may receive data over network 110 from the cloud application. It is expressly noted that the pre-processing steps may include any combination of these examples and/or any other manner of local or remote data processing known to the skilled person.

In step 214, the workflow engine 108 causes transmission of the first data from the computer system 102 to the cloud server system 112. In order to do so, the workflow engine 108 may select a suitable cloud server system 112 from a plurality of potential cloud server systems. The workflow engine 108 may further select a suitable machine learning model from a plurality of machine learning models available on the selected cloud server system. While selecting a cloud server system is described herein, it is expressly noted that the workflow engine 108 may select a suitable machine learning model in a substantially similar manner. The workflow engine 108 may select the cloud server system based on any suitable parameter known to the skilled person. Exemplarily, the workflow engine 108 may select the cloud server system based on user input, such as in the model configuration. The model configuration may provide a list of one or more cloud server systems that are suitable to execute the application in question. The list may be ordered by preference and the workflow engine 108 may select the highest-rank cloud server system currently available, and/or the workflow engine 108 may select a cloud server system based on additional parameters. The workflow engine 108 may also select a cloud server system based on a set of one or more rules defined in the model configuration, the workflow engine itself, and/or that are given as an additional input to the workflow engine. For example, the rules may assist the workflow engine 108 to select the right type of computing resource needed for the machine learning model. Selecting the wrong type of resource may result in longer processing times and/or job failure due to resource constraints. For example, the workflow engine 108, using the rules, may select the cloud server system based on the type of machine learning model and/or its size. A larger model or a model with a large amount of input data requires a cloud server system with more available resources. Illustratively, a large language model requires a larger number of processing cores and a larger amount of memory than a smaller model. Also, certain models fail to run or run very slowly if certain resources are not present. For example, a machine learning model based on TensorFlow or a large language model requires a dedicated graphics processing unit (GPU) available on the cloud server system for successful execution. Other machine learning models may not require dedicated GPU. In another example, the user account that the workflow engine 108 utilizes to access the preferred cloud server system 112 may be restricted to a certain number of instances. If this number of instances is exceeded, the workflow engine 108 may select a different cloud server system or delay execution of the machine learning model until resources are again available. The workflow engine may also leave a certain number of instances unused to allow for ad-hoc processes. For example, the workflow engine may be configured to only utilize 80% of the available instances before triggering another instance to share workload or selecting a different cloud server system or delaying execution. It is also expressly contemplated that the workflow engine may select more than one instance of a machine learning model to execute the workflow. The instances may be executed on the same cloud server system, or they may be executed on more than one cloud server system. For example, the workflow engine 108 may select the appropriate number of instances based on the type of input data for the model and how the data is organized. Input data organized on one big file may be treated differently than input data organized in many small files that all have to be transmitted to the one or more cloud server systems. The workflow engine 108 may further select the cloud server system 112 based on cost. Cloud-based machine learning providers often charge fees based on model size, run time, and/or resource utilization. The workflow engine 108 may use the rules to minimize cost based on known values, such as for model size and required resources, and/or estimated values, such as run time. The workflow engine 108 may select the cloud server system based on any combination of user input, a set of one or more rules, and/or heuristics as described above.

The workflow engine 108 may also select the could server system 112 based on network requirements and/or network status. In some networks, network addresses such as public Internet Protocol (IP) addresses are in short supply and several computer systems share the same public IP. In addition, to access a cloud server system, a public IP is required. IP addresses may be organized in subnetworks and/or network zones to simplify their use and allocation. To optimize the use of available IP addresses, the workflow engine may select the cloud server system 112 based on the number of IP addresses available across all zones in a shared cloud server account and based on the number of resources required for the current workflow. The workflow engine 108 may also select the cloud server system 112 based on the traffic that the workflow requires. For example, real-time execution of a machine learning model that receives live incoming traffic requires a network zone configured for incoming and outgoing traffic. Batch execution of a model that does not receive any live incoming traffic and only relies on stored data merely requires a network zone configured for outgoing traffic. In addition, the workflow engine 108 may adjust the number of parallel executions of machine learning models on one or more cloud server systems based on the number of IP addresses available.

The workflow engine 108 may further select the cloud server system 112 based on information collected during previous executions of the machine learning model. For example, the workflow engine 108 may monitor the performance of the machine learning model during execution, as described below, and base its selection of the cloud server system 112 on the collected performance information. The workflow engine 108 may automatically select the correct type of cloud server system with the correct type of available resources. In addition, the selection of the cloud server system may be enhanced by integrating information collected during previous executions of the machine learning model. For example, a cloud server system that theoretically has enough available resources to execute a certain model but for which the previous two executions resulted in very long execution times may not be selected for a third execution. Instead, the workflow engine may select a different cloud server system. In another example, a cloud server system that would not have been usually selected based on the rules but was selected because of resource constrains in the preferred system and that executed a certain model swiftly with low executions times may be selected again for that type of machine learning model. In such an example, the workflow engine may further notify a user to review and/or update the rules, or the workflow engine may update the rules itself based on the monitored performance.

It is also noted that the workflow engine 108 may select the cloud server system 112 based on the output of a second machine learning model with minimal initial bootstrap configuration. This selection may be performed only based on the second model output, or it may be performed using any combination of the techniques described above and the output of the second machine learning model. The second machine learning model may have any suitable architecture and/or configuration known to the skilled person. For example, the second machine learning model may have been trained with measured performance statistics for different types of models on different types of cloud server systems using different types and sizes of input data. For selecting the cloud server system, the workflow engine 108 then uses the current machine learning model and its input data to cause the second machine learning model to predict the preferred type of cloud server system. The workflow engine 108 may select the cloud server system 112 solely based on that prediction, or it may apply additional rules and/or user input to the prediction. For example, a predicted cloud server system that would result in high costs may not be selected.

After the workflow engine 108 has selected one or more cloud server systems 112, the workflow engine causes transmission of the first data, which includes the inputs for the machine learning model and any other data required to successfully execute the model, from the computer system 102 to the selected cloud server system 112. The transmission may be performed in any suitable way known to the skilled person, for example over network 110. Depending on the selected cloud server system, transmitting the first data may also include using an Application Programming Interface (API) provided by the cloud server system.

In step 216, the workflow engine 108 causes execution of the machine learning model on the cloud server system 112. Depending on the selected cloud server system, the workflow engine may cause execution in any way known to the skilled person. If the selected cloud server system 112 is a publicly available machine learning platform, the workflow engine 108 may cause execution of the machine learning model using an API provided by the platform to execute a model that has already been uploaded. In another example, if the selected cloud server system 112 is an in-house server, the workflow engine 108 may cause execution of the machine learning model by directly connecting to the cloud server system and executing an application or a script that accesses a model already present on the system. The model configuration may define in what manner to cause execution of the model and may also provide any required credentials, such as username and password. It is also expressly contemplated that the workflow engine 108 provides a copy of the machine learning model to the cloud server system 112 before causing execution of the model. Exemplarily, this copy may be a binary file received by the workflow engine together with the model configuration and now transmitted to the cloud server system 112 for execution. In another example, the model configuration may refer to a binary file stored in database 114 or in a file system of the computer system 102 that is transmitted to cloud server system 112 for execution.

The workflow engine 108 and/or the cloud server system 112 may monitor the performance of the machine learning model during its execution. The cloud server system may monitor the performance and then transmit the monitored performance data back to the workflow engine. Alternatively, or in addition, the cloud server system may provide an API or other means for the workflow engine 108 to monitor the status of the cloud server system during execution of the machine learning model. Illustratively, the monitored data may include resource utilization (such as CPU cores, GPU cores, main memory, GPU memory), execution time, data transfer time, used network bandwidth, and/or any other suitable parameter known to the skilled person. The workflow engine 108 may store the performance data in database 114, memory 106, or a file system of computer system 102. The workflow engine 108 may also process the performance data before or after storage in any way known to the skilled person. The performance data may then be utilized to select a suitable cloud server system in a subsequent execution of the model as described above. It is also noted that the workflow engine 108 may analyze the performance data to generate an alert, for example if a resource limit has been exceeded. Alternatively, or in addition, the cloud server system may provide an API or other means for the workflow engine 108 to monitor the performance of the machine learning model and provide metrics related to data quality, model quality, model bias, and model explainability.

In step 218, the workflow engine 108 causes transmission of second data from the cloud server system 112 to the computer system 102. The second data includes an output of the machine learning model. The transmission may be performed in any suitable way known to the skilled person, for example over network 110. Depending on the selected cloud server system, transmitting the second data may also include using an Application Programming Interface (API) provided by the cloud server system.

In step 220, the workflow engine 108 executes the post-processing steps. For example, the workflow engine 108 may utilize a database connection and credentials provided in the model configuration to access a database. The workflow engine 108 may then store data in a given table in a given database. This stored data may include the second data that includes one or more outputs of the machine learning model. In another example, the workflow engine 108 may process the second data during the post-processing steps before storing it. The workflow engine 108 may process the second data in any manner known to the skilled person. For example, the workflow engine 108 may aggregate the second data. In another example, the workflow engine 108 may execute another application to process the second data. The output of that other application is then stored in the database, in the file system, and/or in any other suitable location.

The workflow engine 108 may execute the post-processing steps in any way known to the skilled person. For example, the post-processing steps may refer to one or more scripts that are executed by the workflow engine 108 on computer system 102. The post-processing steps may also refer to separate applications and/or containers that are available for execution on computer system 102. The workflow engine 108 may cause execution of these applications and/or containers to execute the post-processing steps. The post-processing steps may further refer to applications that are available in the cloud over network 110. In that case, the workflow engine 108 may transmit data over network 110 to the cloud application, cause execution of the cloud application, and then may receive data over network 110 from the cloud application. It is expressly noted that the post-processing steps may include any combination of these examples and/or any other manner of local or remote data processing known to the skilled person.

FIG. 3 is an illustration of a system architecture 300 in accordance with an embodiment of the present invention. System architecture 300 reflects what is shown and described above with reference to FIGS. 1 and 2. Workflow engine 310 includes the functions described above with reference to workflow engine 108. Workflow engine 310 is coupled to storage 320 to retrieve input data for the machine learning model and store output data from the machine learning model. Workflow engine 310 is also provided with model execution rules 330. The workflow engine 310 may use the model execution rules 330 alternatively to or in combination with rules defined in the model configuration to select the appropriate cloud server system as described above with reference to step 214 of FIG. 2. The architecture may be broken down into a collection of scripts, for example written in Python or any other suitable scripting language, that execute the various functions. A first script may analyze and validate the model configuration and may also determine whether the first and second prerequisites are met. A second script may run the pre-processing steps, for example to integrate with a database to retrieve model input data. A third script may determine the best cloud server system for the machine learning model as described above. A fourth script may determine a subnet or network zone with the most available number of IP addresses. A fifth script may ascertain that the selected cloud server system is actually available for execution and may adjust the availability of that cloud server system. A sixth script may cause execution of the machine learning model on the cloud server system. A seventh script may receive the output of the machine learning model and run the post-processing steps, for example to store the output in a database. It is noted that while the scripts are numbered herein, they do not have to be executed in the given order. For example, the fifth script may be executed before the fourth script. The scripts may also be combined in any suitable way. For example, a single script could combine the functions of the third, fourth, and fifth scripts.

Notably, the systems and methods described herein may be executed in an automated manner. A user, such as a data scientist, may generate a trained model and any required configuration information, pre-processing steps, and post-processing steps for deployment. The user then adds the model and the associated configuration information to a software repository system such as a Git repository (publicly available at git-scm.com) or any other suitable repository. Adding the model and configuration to the repository has the advantage that the specific version of model and configuration is now version controlled. The workflow engine 108 may search the repository for models that are ready to deploy and have not been processed yet. These may be models that have been newly added to the repository, or it may be models that had a change in their version information, for example because the model weights or the configuration information had been updated. The workflow engine 310/108 may search the repository periodically in a certain time interval, for example once an hour or once a day. The workflow engine 108 then retrieves artifacts and configuration in the ready-to-deploy mode and validates and processes the configuration as described above. The workflow engine may then execute the pre-processing steps, select a cloud server system, and execute the post-processing steps as described above. Alternatively, or in addition, the workflow engine may batch-process all or a subset of the deployed models. Illustratively, the workflow engine may execute the models at a certain time or periodically. The workflow engine may, for example, be configured to cause execution of certain models once a day. In another example, the workflow engine may be configured to cause execution of certain models at times when the required resources are expected to be available, such as during the night.

As described above, the workflow engine 310/108 may also monitor the machine learning models during execution. Monitoring allows to proactively detect changes such as model degradation, data drift, and/or concept drift and to ensure that the model maintains an acceptable level of performance. The desired level of monitoring may be specified in the model configuration and/or by other rules. The workflow engine may alert the user if certain monitored performance metrics exceed predefined limits. The user can then adapt and update the machine learning model as desired and upload a new version of the model to the repository system. The workflow engine then retrieves the new version from the repository and automatically configures it for timely executions.

Embodiments of the present invention may be embodied in many different forms, including, but in no way limited to, computer program logic for use with a processor (e.g., a microprocessor, microcontroller, or digital signal processor), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, Python, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

The foregoing description described certain example embodiments. It will be apparent, however, that other variations and modifications may be made to the described embodiments, with the attainment of some or all of their advantages. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A computer-implemented method for executing a machine learning model on a cloud server system using a workflow engine executing on a computer system, the method comprising:
receiving, by the workflow engine, a model configuration including data related to the machine learning model, pre-processing steps having first prerequisites, and post-processing steps having second prerequisites;
determining, by the workflow engine, whether the first prerequisites are met;
in response to a determination that the first prerequisites are not met, executing, by the workflow engine, first operations such that after execution of the first operations the first prerequisites are met;
determining, by the workflow engine, whether the second prerequisites are met;
in response to a determination that the second prerequisites are not met, executing, by the workflow engine, second operations such that after execution of the second operations the second prerequisites are met;
executing, by the workflow engine, the pre-processing steps to provide first data, the first data including model inputs;
causing, by the workflow engine, transmission of the first data from the computer system to the cloud server system;
causing, by the workflow engine, execution of the machine learning model on the cloud server system;
causing, by the workflow engine, transmission of second data from the cloud server system to the computer system, the second data including an output of the machine learning model; and
executing, by the workflow engine, the post-processing steps.

2. The computer-implemented method of claim 1, wherein the workflow engine is configured to execute the machine learning model on a plurality of different types of cloud server systems.

3. The computer-implemented method of claim 1, wherein the post-processing steps include storing, by the workflow engine, the output of the machine learning model in a database.

4. The computer-implemented method of claim 1, wherein the pre-processing steps include retrieving, by the workflow engine, the model inputs from a database.

5. The computer-implemented method of claim 1, further comprising selecting, by the workflow engine, the cloud server system for executing the machine learning model from a plurality of potential cloud server systems.

6. The computer-implemented method of claim 5, wherein selecting the cloud server system is based on the output of a second machine learning model.

7. The computer-implemented method of claim 5, wherein selecting the cloud server system is based on at least one of a set of rules, heuristics, and user input.

8. The computer-implemented method of claim 5, further comprising monitoring, by at least one of the workflow engine and the cloud server system, a performance of the machine learning model during execution.

9. The computer-implemented method of claim 8, wherein selecting the cloud server system is based on the monitored performance during a previous execution of the machine learning model.

10. The computer-implemented method of claim 1, wherein at least one of the first prerequisites and the second prerequisites include at least one of a storage location and a user access permission.

11. A system for processing a model execution workflow, the system comprising:
a cloud server system configured to execute a machine learning model; and
a computer system having a processor coupled to a memory, the computer system communicatively coupled to the cloud server system, the processor configured to execute a workflow engine, the workflow engine configured to:
receive a model configuration including data related to the machine learning model, pre-processing steps having first prerequisites, and post-processing steps having second prerequisites;
determine whether the first prerequisites are met;
in response to a determination that the first prerequisites are not met, execute first operations such that after execution of the first operations the first prerequisites are met;
determine whether the second prerequisites are met;
in response to a determination that the second prerequisites are not met, execute second operations such that after execution of the second operations the second prerequisites are met;
execute the pre-processing steps to provide first data, the first data including model inputs;
cause transmission of the first data from the computer system to the cloud server system;
cause execution of the machine learning model on the cloud server system;
cause transmission of second data from the cloud server system to the computer system, the second data including an output of the machine learning model; and
execute the post-processing steps.

12. The system of claim 11, wherein the workflow engine is configured to execute the machine learning model on a plurality of different types of cloud server systems.

13. The system of claim 11, further including a database communicatively coupled to the computer system, wherein the post-processing steps include storing the output of the machine learning model in a database.

14. The system of claim 11, further including a database communicatively coupled to the computer system, wherein the pre-processing steps include retrieving the model inputs from a database.

15. The system of claim 11, wherein the workflow engine is further configured to select the cloud server system for executing the machine learning model from a plurality of potential cloud server systems.

16. The system of claim 15, wherein selecting the cloud server system is based on the output of a second machine learning model.

17. The system of claim 15, wherein at least one of the cloud server system and the workflow engine is further configured to monitor a performance of the machine learning model during execution.

18. The system of claim 17, wherein the workflow engine is configured to select the cloud server system based on the monitored performance during a previous execution of the machine learning model.

19. The system of claim 11, wherein at least one of the first prerequisites and the second prerequisites include at least one of a storage location and a user access permission.

20. A non-transitory computer-readable medium having software encoded thereon, the software, when executed by a computer system coupled to a cloud server system, operable to:
receive a model configuration including data related to a machine learning model, pre-processing steps having first prerequisites, and post-processing steps having second prerequisites;
determine whether the first prerequisites are met;
in response to a determination that the first prerequisites are not met, execute first operations such that after execution of the first operations the first prerequisites are met;
determine whether the second prerequisites are met;
in response to a determination that the second prerequisites are not met, execute second operations such that after execution of the second operations the second prerequisites are met;
execute the pre-processing steps to provide first data, the first data including model inputs;
cause transmission of the first data from the computer system to the cloud server system;
cause execution of the machine learning model on the cloud server system;
cause transmission of second data from the cloud server system to the computer system, the second data including an output of the machine learning model; and
execute the post-processing steps.
